(19) United States
(12) Patent Application Publication
(10) Pub. No.: US 2016/0082851 A1
(43) Pub. Date: Mar. 24, 2016

(54) CHARGING SYSTEM AND CHARGING METHOD

(71) Applicant: FUJI ELECTRIC FA COMPONENTS & SYSTEMS CO., LTD., Tokyo (JP)

(72) Inventors: Takayuki USUDA, Konosu (JP); Nobuyori Yoshioka, Kawasaki (JP)

(73) Assignee: FUJI ELECTRIC FA COMPONENTS & SYSTEMS CO., LTD., Tokyo (JP)

(21) Appl. No.: 14/957,162

(22) Filed: Dec. 2, 2015

Related U.S. Application Data
(63) Continuation of application No. PCT/JP2013/070174, filed on Jul. 25, 2013.

(51) Int. Cl. B60L 11/18

(52) U.S. Cl. CPC B60L 11/1816; B60L 11/1838

(57) ABSTRACT

A charging system includes at least one facility connected to a feeder of a contract power source; and a charger connected to the feeder, wherein charging power is output to charge an electrical storage device, such as a battery, by an operation of a power converter in the charger. The charger stores power consumption values of facilities and a rated power value for a power that the charger can output within the range of contract power. A charging power computing section computes charging power by subtracting the total value of the power consumption values of facilities in operation from the rated power value. A power converter charges a battery based on the computed charging power.

### CROSS-REFERENCE TO RELATED APPLICATIONS

This application is a continuation application, filed under 35 U.S.C. §111(a), of International Application PCT/JP2013/070174 filed on Jul. 25, 2013, the disclosure of which is incorporated herein by reference.

### BACKGROUND

1. Field

The present disclosure relates to a charging system for charging an electrical storage device, such as an in-vehicle battery, and to a charging method using the charging system.

2. Related Art

FIG. 4 is a configuration diagram of a heretofore known charging system, simulating, for example, a charging stand or charging station acting as a facility with an electric vehicle (EV) charger. In FIG. 4, a commercial power source 10 acts as a contract power source, and n existing facilities 30₁ to 30ₙ and an EV charger 40 are connected to the commercial power source 10 via a feeder 20.

The EV charger 40 includes a power converter 41 which converts the alternating current power of the commercial power source 10 to direct current power appropriate for charging, a setter 42, and a memory 43. Herein, a configuration is such that charging power which the EV charger 40 can output is prestored in the memory 43 as a proper value, or is stored in the memory 43 by an input operation from the setter 42. The power converter 41, in accordance with a charging power set value (which shall include the heretofore mentioned proper value too) stored in the memory 43, outputs appropriate direct current power while making an exchange of information with an EV 50 via a charging cable 60, thus charging a battery 51.

As a charger for an EV battery, a heretofore known technology described in patent application publication JP-A-8-228406 (Paragraphs [0007] to [0011], FIG. 1, etc.) is publicly known. The charger charges the battery in preference using a first power supply whose power supply time zone is fixed, and in other than the power supply time zone, charges the battery using a second power supply whose power supply time zone is not limited. FIG. 5 is a configuration diagram of the charger, wherein 101 is a power plug connected to a 200[V] power source acting as a midnight power source, 102 is a power plug connected to a 100[V] power source, 103 is a tap changing circuit, 104 is a transformer, 105 is a phase control circuit, 106 is a rectifier circuit, 107 is a voltage detector, 108 is a current detector, 109 is a temperature detector, 110 is a hydrogen concentration detector, 111 is a DC/AC inverter, 112 is a DC/DC converter, 120 is a control section, 121 is an operation key section, 122 is a display device, B₁ is a main battery, B₂ is an auxiliary battery for an auxiliary machine, and M is a vehicle drive motor.

In the heretofore known technology, the tap changing circuit 103 determines a power source type (the 200[V] power source and/or the 100[V] power source) connected to the charger and sends this information to the control section 120. The control section 120 sends a control signal to the tap changing circuit 103 in response to the power source type, opens and closes a contact, and inputs a predetermined power source voltage into the charger. Further, the control section 120 charges the main battery B₁ by constant voltage control or constant current control while monitoring the voltage, current, temperature, and the like, of the main battery B₁ using the respective detectors 107 through 110.

Herein, a configuration is adopted such that when it is determined by the tap changing circuit 103 that both the 200[V] power source and 100[V] power source are connected, the main battery B₁ is charged with power supplied from the 200[V] power source in the power supply time zone of the 200[V] power source, while the main battery B₁ is charged with power supplied from the 100[V] power source in other than the power supply time zone of the 200[V] power source.

### SUMMARY

In the heretofore known technology shown in FIG. 4, contract power is set between an electric power company which supplies the commercial power source 10 and a power receiving side facility. However, supposing that there are three existing facilities (facilities 30₁, 30₂, and 30₃), as shown in FIG. 6, and taking into account that there is also the possibility of all the facilities 30₁, 30₂, and 30₃ being simultaneously operated depending on the time zone, utilizable power is “rated power set value−total power consumption of (facility 30₁+facility 30₂+facility 30₃)” when setting the charging power of the EV charger 40 as a fixed value. In other words, when setting the charging power as a fixed value, the charging power is set to be low, thereby preventing the fear of affecting the operation of the facilities 30₁, 30₂, and 30₃.

In this case, however, the output of the EV charger 40 becomes used within the range of “charging power” shown in FIG. 6, and “remaining power” marked with oblique lines cannot be utilized as charging power, meaning that it is not possible to take full advantage of the ability of the EV charger 40. Also, there is also the problem that as the charging power is set to be low, charging time becomes longer, which is not suitable for short-time charging such as fast charging.

As opposed to this, when the charging power of the EV charger 40 is fixed to a great value, a plurality of facilities are simultaneously operated, due to which the total value, of the charging power and the total power consumption of the plurality of facilities, exceeds the contract power. In order to prevent this kind of situation, it is necessary to revise into a contract with excess power taken into account, or conclude a new contract for exclusive use of EV charger with an electric power company, but a rise in power rates is caused as a result.

In the heretofore known technology described in patent application publication JP-A-8-228406, it is possible to reduce cost to some extent by utilizing midnight power, but it is necessary to contract with two power source systems, and a circuit configuration such as the tap changing circuit is complex. Also, means which maximizes the charging power within the range of the contract power is not particularly referred to in patent application publication JP-A-8-228406.

Therefore, a problem to be solved by this disclosure lies in providing a charging system and charging method which enable short-time charging of an electrical storage device at low cost by making maximum use of utilizable power which varies in accordance with the operational status of an existing facility within contract power.

In order to solve the heretofore described problem, a charging system according to a first aspect of the present invention is premised on a charging system including a facility connected to a feeder of a contract power source such as a commercial power source; and a charger connected to the feeder, wherein charging power is output by an operation of a power converter in the charger, thus charging an electrical storage device such as an in-vehicle battery.

Further, a feature of the charging system is such that the charger includes a power consumption storage section in which a power consumption value of the facility is prestored; a rated power storage section in which a rated power value is prestored and which the charger can output within the range of contract power; and a charging power computing section which computes charging power by subtracting the power consumption value of the facility in operation from the rated power value, and that the power converter is operated with the charging power, computed by the charging power computing section, as an output power command value, thereby charging the electrical storage device.

According to a second aspect of the present invention, it is desirable that when a plurality of the facilities exist, the charging power computing section retrieves respective power consumption values of facilities in operation from the power consumption storage section, and computes charging power by subtracting the total value of the retrieved power consumption values from the rated power value.

According to a third aspect of the present invention, it is desirable that the facility transmits an operation signal to the charger when the facility is in operation, and the charger, when receiving the operation signal, retrieves the power consumption value of the facility from the power consumption storage section.

According to a fourth aspect of the present invention, a maximum power consumption value of the facility may be stored in the power consumption storage section, and information on the ratio of a present power consumption value to the maximum power consumption value of the facility may be included in the operation signal. In this case, the charging power computing section, with a multiplication value of the maximum power consumption value of the facility, retrieved from the power consumption storage section, and the ratio information, included in the operation signal, as the power consumption value of the facility, sums up the power consumption values of facilities in operation, and subtracts the sum from the rated power value, thereby computing charging power.

According to a fifth aspect of the present invention, a charging method is such that in a charging system, which includes a facility connected to a feeder of a contract power source; and a charger connected to the feeder, wherein charging power is output by an operation of a power converter in the charger, thus charging an electrical storage device, the charger prestores a rated power value, which the charger can output within the range of contract power, and a power consumption value of the facility, and computes charging power by subtracting the power consumption value of the facility in operation from the rated power value, and the power converter is operated with the computed charging power as an output power command value, thus charging the electrical storage device.

According to a sixth aspect of the present invention, it is desirable that when there are a plurality of facilities, charging power is computed by subtracting the total value of respective power consumption values of facilities in operation from the rated power value.

According to embodiments of the present invention, the operation condition of facilities supplied with power from the same contract power source as that of the charger is comprehended, and charging power is obtained by subtracting the total value of the power consumption values of facilities in operation from the rated power value of the charger. Therefore, charging power which can be utilized at the present moment is computed in real time, and the power converter is operated with the charging power as an output voltage command value, thereby enabling short-time charging to be carried out making maximum use of remaining power within contract power. Also, it is possible to provide an overall low-cost charging system which eliminates an economic burden when contracting with two power source systems, and the need of a complex circuit configuration, such as a tap changing circuit, as in patent application publication JP-A-8-228406.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a configuration diagram of a charging system according to an embodiment of the invention.

FIG. 2 is an illustration of charging power in the embodiment of the invention.

FIG. 3 is a configuration diagram showing another working example of an EV charger in the embodiment of the invention.

FIG. 4 is a configuration diagram showing a heretofore known technology of a charging system.

FIG. 5 is a configuration diagram of a heretofore known technology.

FIG. 6 is an illustration of charging power in the charging system shown in FIG. 4.

### DESCRIPTION OF EMBODIMENTS

The following describes embodiments with reference to accompanying drawings.

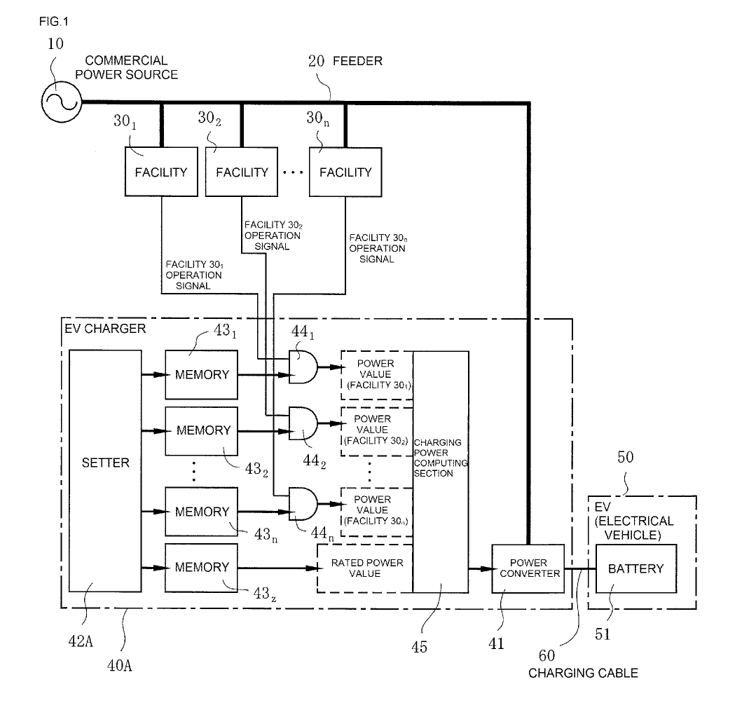

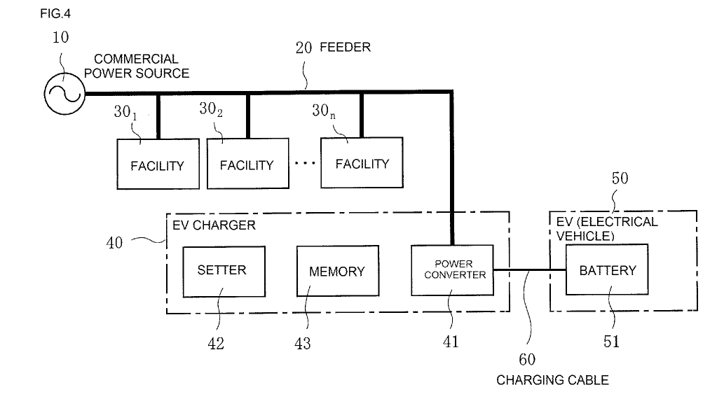

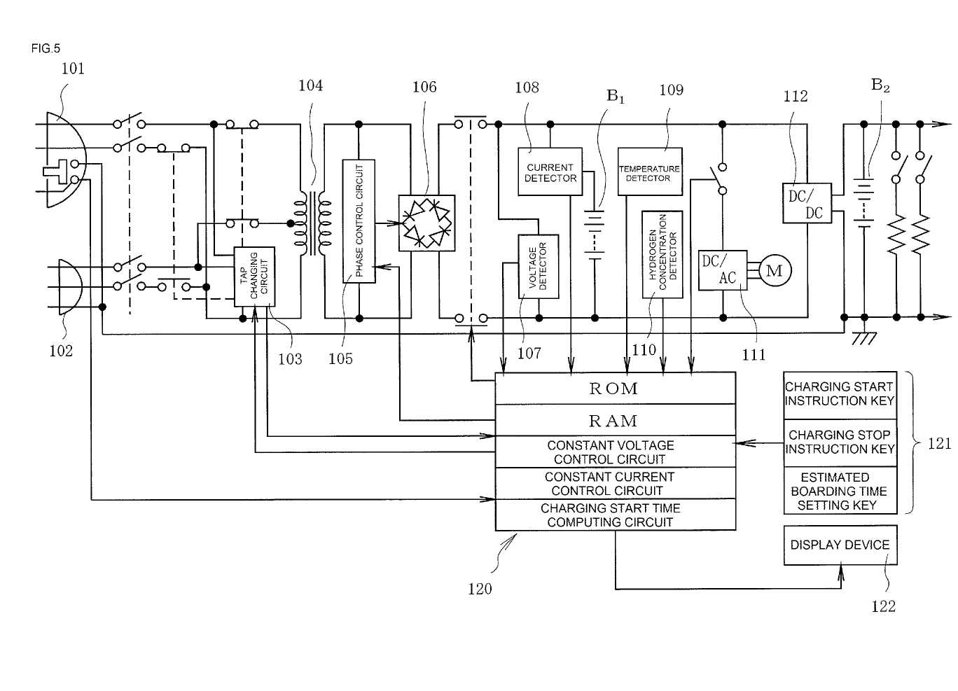

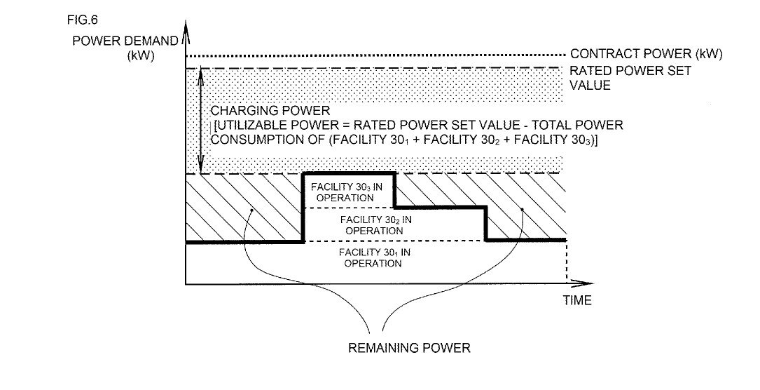

FIG. 1 shows an overall configuration of a charging system according to an embodiment, and identical signs are given to components having the same functions as in FIG. 4. The charging system is also premised on a charging stand, a charging station, or the like, which has n existing facilities 30₁ to 30ₙ, which is supplied with power via a feeder 20 from a commercial power source 10 acting as a contract power source, and an EV charger 40A. The charging facilities may be of any form, such as an existing gas station, storefront, public facility, or expressway (toll road) service area.

In FIG. 1, operation signals, acting as digital electrical signals, generated when the respective facilities are in operation are input into the EV charger 40A from the facilities 30₁ through 30ₙ. The EV charger 40A includes a setter 42A, memories 43₁ through 43ₙ acting as a power consumption storage section, a memory 43_{z} acting as a rated power storage section, AND gates 44₁ through 44ₙ, a charging power computing section 45, and a power converter 41. Herein, the setter 42A, the memories 43₁ through 43ₙ and 43_{z}, the AND gates 44₁ through 44ₙ, and the charging power computing section 45 can be configured of, for example, a microcomputer system and a program. Also, the power converter 41 is configured of an AC/DC converter.

Operation signals output from the facilities 30₁ through 30ₙ, not being limited to digital electrical signals, may be analog electrical signals, which indicate that the facilities are in operation, or optical signals transmitted via an optical fiber. Also, the method of communication of the operation signals may be either wire communication or wireless communication. When using signals other than digital electrical signals as the operation signals, processing such as signal conversion is needed on the EV charger 40A side depending on the kind and property of the operation signals.

The setter 42A can set the respective power consumption values of the facilities 30₁ to 30ₙ when in operation, and the power consumption values are stored in the memories 43₁ through 43ₙ provided corresponding to the respective facilities 30₁ through 30ₙ. Herein, the power consumption value only has to be a maximum power consumption value or rated power consumption value of each facility. Also, the setter 42A can also set a rated power value of the EV charger 40A, and the rated power value is stored in the separately provided memory 43_{z}.

The AND gates 44₁ through 44ₙ are for loading the power consumption values of the respective facilities 30₁ through 30ₙ onto the subsequent charging power computing section 45 when the facilities 30₁ through 30ₙ are in operation, and the operation signals output from the facilities 30₁ through 30ₙ and the outputs of the memories 43₁ through 43ₙ are input into the AND gates 44₁ through 44ₙ respectively. Also, the rated power value stored in the memory 43_{z} is input directly into the charging power computing section 45.

The charging power computing section 45, based on the outputs of the AND gates 44₁ through 44ₙ, compute the total value of the power consumption values of all the facilities in operation. At the same time, the charging power computing section 45 retrieves the rated power value stored in the memory 43_{z} and carries out the computation of the following equation 1, thereby obtaining charging power, which can be utilized at the present moment, in real time.

Utilizable power=set value of rated power−total power consumption of facility in operation [Equation 1]

The charging power computed in this way is given, as an output power command value, to the power conversion section 41 from the charging power computing section 45, and the power conversion section 41 outputs charging power compatible with the command value to a battery 51 of an EV 50, which is an electrical storage device, thus carrying out charging.

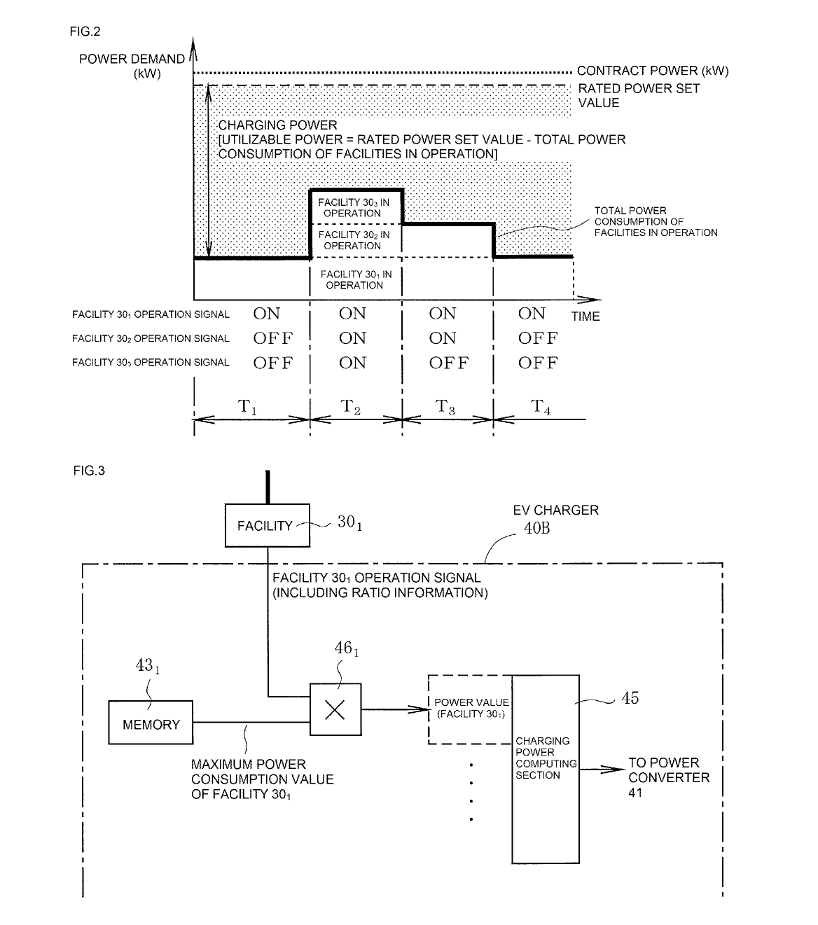

FIG. 2 is an illustration of charging power in the charging system of the embodiment. Herein, it is supposed that there are three existing facilities (the facilities 30₁, 30₂, and 30₃), and that the facilities 30₁, 30₂, and 30₃ are caused to operate in the pattern of a period T₁ (the facility 30₁ operates)→a period T₂ (the facilities 30₁, 30₂, and 30₃ operate)→a period T₃ (the facilities 30₁ and 30₂ operate)→a period T₄ (the facility 30₁ operates) along the time axis.

In each period T₁ through T₄, the power consumption value of the facility in operation is input into the charging power computing section 45 via each respective AND gate 44₁ through 44ₙ in real time, and the charging power computing section 45 computes charging power, which can be utilized at the present moment, by the previously described computation of the equation 1, thus generating the command value for the power converter 41.

Therefore, by operating the power converter 41 in accordance with the command value, it is possible to charge the battery 51 all over the periods T₁ through T₄ by maximizing the use of the charging power in FIG. 2. As a charging method, either standard charging or fast charging may be used.

FIG. 3 is another working example (indicated by sign 40B) of the EV charger. Herein, as one example, only a portion which processes the operation signal from the facility 30₁ is extracted, and portions which process the operation signals from the other facilities 30₂ through 30ₙ are also configured in the same way.

In the working example, the maximum power consumption values of the facilities 30₁ through 30ₙ are set and stored in the memories 43₁ through 43ₙ respectively, and information on the ratio (0% (when in non-operation) to 100%) of the present power consumption value to the maximum power consumption value is included in the operation signal output from each facility 30₁ through 30ₙ. This kind of ratio information can be realized by appropriately changing, for example, a pulse amplitude, a pulse width, or a frequency (the number of pulses) when the operation signals output from the facilities 30₁ through 30ₙ are digital signals.

That is, as shown in FIG. 3, the maximum power consumption value of the facility 30₁ is stored in the memory 43₁, and the present power consumption value of the facility 30₁ is obtained by multiplying means 46₁ multiplying the maximum power consumption value of the facility 30₁ and the ratio information included in the operation signal from the facility 30₁. The obtained power consumption value is sent to the charging power computing section 45 together with the present power consumption values of the other facilities 30₂ through 30ₙ individually obtained in the same way. Therefore, the charging power computing section 45, by subtracting the total value of the present power consumption values of the facilities 30₁ through 30ₙ from the rated power value, can obtain charging power, the use of which can be maximized at the present moment. As the subsequent operation is the same as heretofore described, a description is omitted.

Embodiments of the invention can be utilized for the charging system or charging method of an electrical storage device used as an in-vehicle battery of overall automobiles, including not only an EV, but a hybrid automobile, or as a direct current power supply, not only for an automobile, but of each kind of electrical equipment or apparatus.

Reference signs and numerals are as follows:
10: Commercial power source
20: Feeder
30₁ to 30ₙ: Facility
40A, 40B: EV charger
41: Power converter
42A: Setter
43₁ to 43ₙ, 43_{z}: Memory
44₁ to 44ₙ: AND gate
45: Charging power computing section 46₁: Multiplying means
50: EV (electrical vehicle)
51: Battery
60: Charging cable

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A charging system, comprising:
a facility connected to a feeder of a contract power source; and
a charger to charge an electrical storage device, the charger connected to the feeder and including
a power consumption storage section storing a power consumption value of the facility,
a rated power storage section storing a rated power value, which is a value of a rated power that the charger can output within a range of the contract power,
a charging power computing section that computes a computed charging power by subtracting the stored power consumption value of the facility upon the charger determining that the facility is in operation, from the rated power value, and
a power converter that receives the computed charging power as a command signal and outputs power based on the command signal to thereby charge the electrical storage device.

2. The charging system according to claim 1, comprising:
a plurality of the facilities, wherein
the charging power computing section retrieves, from the power consumption storage section, respective power consumption values of each of the facilities determined to be in operation, and computes the computed charging power by subtracting a total value of the retrieved power consumption values from the rated power value.

3. The charging system according to claim 1, wherein
the facility transmits an operation signal to the charger when the facility is in operation, and
the charger, when receiving the operation signal, retrieves the power consumption value of the facility from the power consumption storage section.

4. The charging system according to claim 2, wherein
each of the plurality of facilities transmits an operation signal to the charger when in operation, and
the charger, when receiving the operation signal, retrieves the power consumption value of the respective facility from the power consumption storage section.

5. The charging system according to claim 3, wherein
a maximum power consumption value of the facility is stored in the power consumption storage section, and the operation signal includes information on the ratio of a present power consumption value to the maximum power consumption value of the facility, and
the charging power computing section sets a multiplication value of the maximum power consumption value of the facility, retrieved from the power consumption storage section, and a ratio information, included in the operation signal, as the power consumption value of the facility.

6. The charging system according to claim 4, wherein
a maximum power consumption value of each of the plurality of facilities is stored in the power consumption storage section, and the operation signal includes information on the ratio of a present power consumption value to the maximum power consumption value of the respective facility, and
the charging power computing section sets a multiplication value of the maximum power consumption value of each of the plurality of facilities, retrieved from the power consumption storage section, and a ratio information, included in the operation signal, as the power consumption value of the respective facility.

7. The charging system according to claim 1, comprising:
a plurality of the facilities, wherein
the charger monitors, across a plurality of time periods, an operation status of each of the plurality of facilities, and
in each of the plurality of time periods, the charging power computing section computes the computed charging power by subtracting, from the rated power value, a total value of the retrieved power consumption values of all of the facilities determined to be in operation during the respective time period.

8. The charging system according to claim 1, wherein the electrical storage device is an in-vehicle battery.

9. The charging system according to claim 2, wherein the electrical storage device is an in-vehicle battery.

10. The charging system according to claim 3, wherein the electrical storage device is an in-vehicle battery.

11. The charging system according to claim 4, wherein the electrical storage device is an in-vehicle battery.

12. The charging system according to claim 5, wherein the electrical storage device is an in-vehicle battery.

13. The charging system according to claim 6, wherein the electrical storage device is an in-vehicle battery.

14. The charging system according to claim 7, wherein the electrical storage device is an in-vehicle battery.

15. A charging method of using a charging system that includes a facility connected to a feeder of a contract power source and a charger connected to the feeder, the charger having a power converter configured to charge an electrical storage device, the method comprising:
storing, in the charger, a rated power value, which is a value of a rated power that the charger can output within the range of contract power, and a power consumption value of the facility;
computing a computed charging power by subtracting the power consumption value of the facility, determined to be in operation, from the rated power value; and
outputting power from the power converter based on the computed charging power to thereby charge the electrical storage device.

16. The charging method according to claim 15, wherein
the computed charging power is computed by subtracting the total value of respective power consumption values of facilities in operation, of a plurality of the facilities, from the rated power value.
